(19) United States
(12) Patent Application Publication
(10) Pub. No.: US 2026/0091824 A1
(43) Pub. Date: Apr. 2, 2026

(54) VEHICLE SIDE SILL STRUCTURE

(71) Applicants: HYUNDAI MOTOR COMPANY, Seoul (KR); KIA CORPORATION, Seoul (KR)

(72) Inventors: Joo Yeon Kim, Hwaseong-si (KR); Joong Su Yun, Hwaseong-si (KR); Jeon Woong Kang, Hwaseong-si (KR)

(73) Assignees: HYUNDAI MOTOR COMPANY, Seoul (KR); KIA CORPORATION, Seoul (KR)

(21) Appl. No.: 19/083,909

(22) Filed: Mar. 19, 2025

(30) Foreign Application Priority Data
Sep. 30, 2024 (KR) 10-2024-0133052

(51) Int. Cl. B62D 25/02; B60K 1/00

(52) U.S. Cl. CPC B62D 25/025; B60K 1/00; B60K 2001/005

(57) ABSTRACT

A vehicle side sill structure includes: a side sill that can be connected to an edge of a floor of a vehicle; a cooling pipe accommodated in an interior space of the side sill and extending in a longitudinal direction of the side sill; and support pads configured and arranged to support the cooling pipe in the longitudinal direction of the side sill.

### CROSS-REFERENCE TO RELATED APPLICATION

This application is based on and claims the benefit of priority to Korean Patent Application No. 10-2024-0133052, filed on Sep. 30, 2024, in the Korean Intellectual Property Office, the disclosure of which is incorporated herein in its entirety by reference.

### TECHNICAL FIELD

The present disclosure relates to a vehicle side sill structure, and more particularly, to a vehicle side sill structure having a space to accommodate cooling pipes.

### BACKGROUND

An electric vehicle (EV) may include a pair of side sills provided on each side edge of a floor and a battery disposed below the floor. The battery may be located between the pair of side sills. Each side sill may include an absorption space that absorbs impact energy in the event of a side collision/impact experienced by the vehicle and may include a mounting surface on which the battery is mounted.

The EV may include a power electronics (PE) cooling system configured to maintain PE components of a PE system at appropriate temperatures so as to ensure driving safety. The PE cooling system of the EV may include a plurality of cooling pipes allowing a coolant to circulate.

With the development of high-performance EVs, a high-output battery, a high-output motor, and the like may be applied to the EV. In this regard, the width of the battery may thus be relatively increased, and the outer diameter of the cooling pipes used to cool the PE components may be larger.

According to the related art, the cooling pipes may be disposed in a space between the battery and the side sill together with a brake pipe, an air pipe, and the like.

However, when the outer diameter of the cooling pipes is increased with the development of high-performance EVs, the space between the battery and the side sill may be reduced. Thus, the installation of the cooling pipes may not be facilitated, and the layout of the cooling pipes may become complex. In addition, it may be difficult to apply the high-output battery, the high-output motor, and the like to the EV, and the performance and durability of the PE system may be insufficient.

The above information described in this background section is provided to assist in understanding the background of the inventive concept. Thus, the above information may include technical concepts that are not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle side sill structure designed to have a space to accommodate cooling pipes, thereby facilitating the installation of the cooling pipes. Another aspect of the present disclosure provides a vehicle that includes such side sills.

According to an aspect of the present disclosure, a vehicle side sill structure may include a side sill connected to or configured to connect to an edge of a floor of a vehicle. The side sill structure may also include a cooling pipe accommodated in an interior space of the side sill and extending in a longitudinal direction of the side sill. The side sill structure may further include a plurality of support pads supporting or configured to support the cooling pipe in the longitudinal direction of the side sill.

The support pads may be spaced apart from each other in the interior space of the side sill.

Each support pad may have a hole into which the cooling pipe is inserted or through which the cooling pipe is received.

The side sill may include an inboard-side wall with a surface that faces or is configured to face in the interior of the vehicle. The side sill may also include an outboard-side wall with a surface that faces or is configured to face the exterior of the vehicle. The side sill may further include a bottom wall with a surface that faces or is configured to face the bottom of the vehicle. The side sill may also include a horizontal rib provided or oriented horizontally in the interior space of the side sill and a vertical rib provided or oriented vertically in the interior space of the side sill. The interior space of the side sill may be partitioned into a first cavity adjacent to the inboard-side wall and a second cavity adjacent to the outboard-side wall by the vertical rib.

The plurality of support pads may be mounted in the second cavity.

Each support pad may have an inboard-side surface contacting the vertical rib, a top surface contacting the horizontal rib, a bottom surface contacting the bottom wall, and an outboard-side surface spaced apart from the outboard-side wall.

Each support pad may include an upper recess provided in a top surface thereof and a lower recess provided in a bottom surface thereof. The side sill may include an upper projection protruding from the horizontal rib toward the bottom wall and a lower projection protruding from the bottom wall toward the horizontal rib. The upper projection may be fitted into the upper recess and the lower projection may be fitted into the lower recess.

A side mount of a battery assembly, which may be disposed below the floor may be mounted on the bottom wall of the side sill through mounting hardware. The mounting hardware may be received in the first cavity of the side sill.

The side sill may further include a brake tube holder attached to the inboard-side wall. The brake tube holder may be configured to hold a brake tube extending along the inboard-side wall of the side sill.

The side sill may further include a stud protruding from the inboard-side wall away from the side sill toward the interior of the vehicle. The brake tube holder may be mounted on the stud.

The cooling pipe may be configured to fluidly connect power electronics (PE) components, such as a front PE component disposed in a front portion of the vehicle and a rear PE component disposed in a rear portion of the vehicle.

The vehicle side sill structure may further include a side sill molding mounted on the outboard-side wall of the side sill.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates a vehicle side sill structure according to an embodiment of the present disclosure; and

FIG. 2 illustrates a cross-sectional view, taken along line A-A, of the vehicle side sill structure of FIG. 1.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure has been omitted in order not to unnecessarily obscure the gist of the present disclosure.

Terms such as first, second, A, B, (a), and (b) may be used to describe the elements in embodiments of the present disclosure. These terms are only used to distinguish one element from another element. The intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or to perform that operation or function.

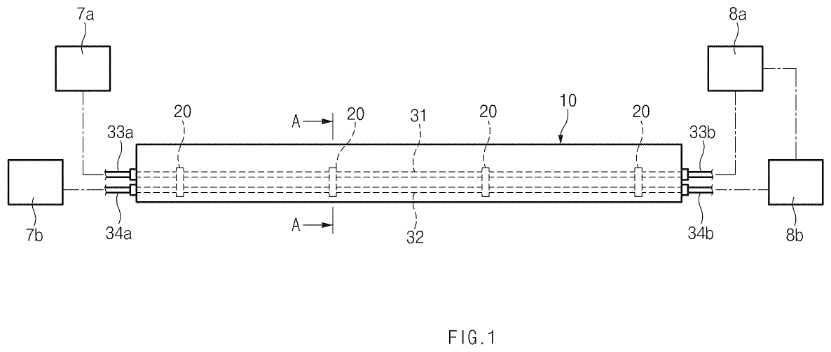

Referring to FIG. 1, a vehicle side sill structure according to an embodiment of the present disclosure may include a side sill 10 and a plurality of cooling pipes 31 and 32 accommodated in an interior space of the side sill 10.

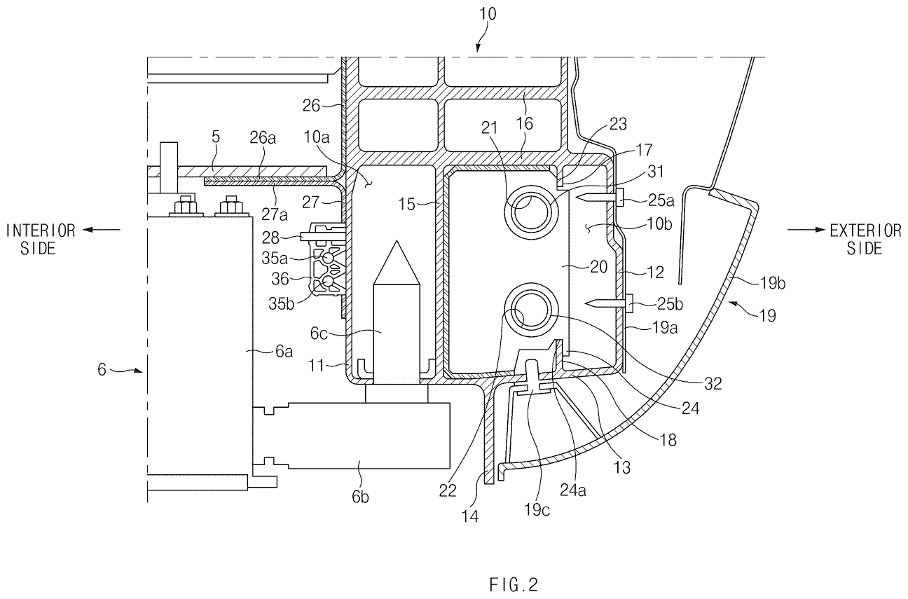

A pair of the side sills 10 may be respectively connected to each side edge of a floor 5 of a vehicle. Referring to FIG. 2, each side sill 10 may be connected to the corresponding edge of the floor 5 and the side sill 10 may extend in a longitudinal direction of a vehicle.

Each of the cooling pipes 31 and 32 may extend in a longitudinal direction of the side sill 10. Each of the cooling pipes 31 and 32 may be supported horizontally in the interior space of the side sill 10 by a plurality of support pads 20. The plurality of support pads 20 may be spaced apart from each other in the interior space of the side sill 10. The plurality of support pads 20 may support or be configured to support the plurality of cooling pipes 31 and 32 in the longitudinal direction of the side sill 10 so that the plurality of cooling pipes 31 and 32 may be prevented from sagging in the interior space of the side sill 10.

Referring to FIG. 1, each of the cooling pipes 31 and 32 may have an interior space, which allows a coolant to flow therethrough. Each of the cooling pipes 31 and 32 may be fluidly connected to power electronics (PE) components of a PE cooling system. The plurality of cooling pipes 31 and 32 may be configured to fluidly connect one or a plurality of front PE components 7a and 7b disposed in a front portion of the vehicle and one or a plurality of rear PE components 8a and 8b disposed in a rear portion of the vehicle. Each of the front PE components 7a and 7b may have a coolant passage, either inside or outside thereof. Likewise, each of the rear PE components 8a and 8b may have a coolant passage, either inside or outside thereof. For example, the first front PE component 7a may be a controller, the second front PE component 7b may be a front inverter, the first rear PE component 8a may be a cooler of a rear motor, and the second rear PE component 8b may be a rear inverter.

A front end of the first cooling pipe 31 may be aligned with a front end of the side sill 10 and a rear end of the first cooling pipe 31 may be aligned with a rear end of the side sill 10. A first front cooling hose 33a may be fluidly connected to the first front PE component 7a. The first front cooling hose 33a may be connected to the front end of the first cooling pipe 31 through a connector in a sealed manner. A first rear cooling hose 33b may be fluidly connected to the first rear PE component 8a. The first rear cooling hose 33b may be connected to the rear end of the first cooling pipe 31 through a connector in a sealed manner. For example, the coolant may be directed from the first rear PE component 8a to the first front PE component 7a through the first rear cooling hose 33b, the first cooling pipe 31, and the first front cooling hose 33a.

A front end of the second cooling pipe 32 may be aligned with the front end of the side sill 10 and a rear end of the second cooling pipe 32 may be aligned with the rear end of the side sill 10. A second front cooling hose 34a may be fluidly connected to the second front PE component 7b. The second front cooling hose 34a may be connected to the front end of the second cooling pipe 32 through a connector in a sealed manner. A second rear cooling hose 34b may be fluidly connected to the second rear PE component 8b. The second rear cooling hose 34b may be connected to the rear end of the second cooling pipe 32 through a connector in a sealed manner. For example, the coolant may be directed from the second front PE component 7b to the second rear PE component 8b through the second front cooling hose 34a, the second cooling pipe 32, and the second rear cooling hose 34b.

Referring to FIG. 2, the side sill 10 may include an inboard-side wall 11 with a surface that faces in a direction, i.e., a laterally inward direction, toward the interior of the vehicle. The side sill 10 may also include an outboard-side wall 12 with a surface that faces in a direction, i.e., in a laterally outward direction, toward the exterior of the vehicle. The side sill 10 may further include a bottom wall 13 with a surface that faces in a downward direction similar to the bottom of the vehicle. The side sill 10 may also include a top wall (not shown) with a surface that faces in an upward direction toward the top of the vehicle. In addition, the side sill 10 may include a projection 14 protruding downward from the bottom wall 13.

Referring to FIG. 2, the side sill 10 may have the interior space defined by the inboard-side wall 11, the outboard-side wall 12, the bottom wall 13, and the top wall (not shown). The plurality of cooling pipes 31 and 32 may be accommodated in the interior space of each side sill 10.

Referring to FIG. 2, the side sill 10 may further include an upper bracket 26 and a lower bracket 27 fixed to the inboard-side wall 11 using fasteners, welding, and/or the like. The upper bracket 26 may have an upper flange 26a bent in a laterally inward direction toward the floor 5. The lower bracket 27 may have a lower flange 27a bent in a laterally inward direction toward the floor 5. The upper flange 26a of the upper bracket 26 may be fixed to the lower flange 27a of the lower bracket 27. The edge of the floor 5 may be fixed to the upper flange 26a of the upper bracket 26 and the lower flange 27a of the lower bracket 27 using fasteners, welding, and/or the like.

The side sill 10 may include one or more vertical ribs 15 and one or more horizontal ribs 16 provided in the interior space thereof. The interior space of the side sill 10 may be partitioned into a plurality of cavities by the vertical and horizontal ribs 15 and 16.

The vertical rib 15 may extend or be oriented vertically in the interior space of the side sill 10. The vertical rib 15 may vertically connect the bottom wall 13 and the top wall (not shown). The horizontal rib 16 may extend or be oriented horizontally in the interior space of the side sill 10. The horizontal rib 16 may horizontally connect the inboard-side wall 11 and the outboard-side wall 12.

The vertical rib 15 may partition the interior space of the side sill 10 into a first cavity 10a adjacent to the inboard-side wall 11 and a second cavity 10b adjacent to the outboard-side wall 12. The first cavity 10a and the second cavity 10b may be partitioned by the plurality of horizontal ribs 16.

Referring to FIG. 2, a battery assembly 6 may be disposed below the floor 5 of the vehicle. The battery assembly 6 may be mounted on the floor 5 and the side sill 10 through mounting hardware. The battery assembly 6 may include a battery case 6a enclosing a plurality of battery cells and may include a side mount 6b extending from a side surface of the battery case 6a toward the side sill 10. The side mount 6b of the battery assembly 6 may be fixed to the bottom wall 13 of the side sill 10 through the mounting hardware 6c. The mounting hardware 6c may be received in the first cavity 10a of the side sill 10.

Referring to FIG. 2, each support pad 20 may include a first hole 21 into which the first cooling pipe 31 is inserted or through which the first cooling pipe 31 is received. Each support pad 20 may also include a second hole 22 into which the second cooling pipe 32 is inserted or through which the second cooling pipe 32 is received.

Referring to FIG. 2, the support pads 20 may be firmly fixed within the interior space of the side sill 10. The support pads 20 may be received in the second cavity 10b of the side sill 10. The support pad 20 may have a top surface contacting the horizontal rib 16 adjacent to the bottom wall 13 of the side sill 10, an inboard-side surface contacting the vertical rib 15 of the side sill 10, an outboard-side surface spaced apart from the outboard-side wall 12 of the side sill 10, and a bottom surface contacting the bottom wall 13 of the side sill 10.

Referring to FIG. 2, the support pads 20 may include an upper recess 23 provided in the top surface thereof and a lower recess 24a provided in the bottom surface thereof. The upper recess 23 may be open to the outboard-side wall 12 and the lower recess 24a may be defined by a support shoulder 24. The side sill 10 may include an upper projection 17 protruding from the horizontal rib 16 adjacent to the bottom wall 13 toward the bottom wall 13. The side sill 10 may also include a lower projection 18 protruding from the bottom wall 13 toward the horizontal rib 16. The upper projection 17 of the side sill 10 may be fitted into the upper recess 23 of the support pad 20. The lower projection 18 of the side sill 10 may be fitted into the lower recess 24a of the support pad 20. Accordingly, the support pad 20 may be firmly mounted in the second cavity 10b of the side sill 10 so that side crashworthiness of the side sill 10 may be improved.

Referring to FIG. 2, the side sill 10 may further include a brake tube holder 36 attached to the inboard-side wall 11, such as on the surface of the inboard-side wall 11 that faces in the direction toward the vehicle interior. The brake tube holder 36 may be disposed between the side sill 10 and the battery assembly 6. The brake tube holder 36 may be configured to hold one or more brake tubes, such as brake tubes 35a and 35b extending along the inboard-side wall 11 of the side sill 10. Each of the brake tubes 35a and 35b may extend from an electronic stability control (ESC) located in the front of the vehicle to a rear-wheel brake mechanism of the vehicle.

Referring to FIG. 2, the side sill 10 may further include a stud 28 protruding from the inboard-side wall 11 toward the interior of the vehicle. The brake tube holder 36 may have a through hole into which the stud 28 is inserted or a hole into which the stud 28 is inserted. Accordingly, the stud 28 may be inserted or extend into the through hole of the brake tube holder 36 so that the brake tube holder 36 may be mounted on the stud 28.

Referring to FIG. 2, the vehicle side sill structure according to an embodiment of the present disclosure may further include a side sill molding 19 mounted on the outboard-side wall 12 of the side sill 10. The side sill molding 19 may include a mounting wall 19a mounted on the outboard-side wall 12 of the side sill 10 and may include a cover wall 19b connected to the mounting wall 19a. The mounting wall 19a may be mounted on the outboard-side wall 12 of the side sill 10 via a plurality of fasteners 25a and 25b. The cover wall 19b may have a clip 19c provided on a lower edge thereof. The clip 19c may be fixed to a through hole of the bottom wall 13 of the side sill 10 so that the cover wall 19b may be mounted on the side sill 10.

As set forth above, the vehicle side sill structure according to embodiments of the present disclosure may be designed to have a space to accommodate the cooling pipes so that the installation of the cooling pipes may be facilitated and so that the layout of the cooling pipes may be compact and simplified. In addition, it may be easy to apply a high-output battery, a high-output motor, and the like to the vehicle. Also, the performance and durability of the PE system may be sufficiently secured.

Hereinabove, although the present disclosure has been described with reference to various embodiments and the accompanying drawings, the present disclosure is not limited thereto. The embodiments may be variously modified and altered by those of ordinary skill in the art to which the present disclosure pertains without departing from the spirit and scope of the present disclosure claimed in the following claims.

What is claimed is:

1. A vehicle side sill structure, comprising:
a side sill configured to be connected to an edge of a floor of a vehicle;
a cooling pipe accommodated in an interior space of the side sill, the cooling pipe extending in a longitudinal direction of the side sill; and
support pads configured and arranged to support the cooling pipe in the longitudinal direction of the side sill.

2. The vehicle side sill structure according to claim 1, wherein the support pads are spaced apart from each other in the interior space of the side sill.

3. The vehicle side sill structure according to claim 1, wherein each support pad of the support pads has a hole through which the cooling pipe is received.

4. The vehicle side sill structure according to claim 1, wherein:
the side sill includes an inboard-side wall, an outboard-side wall, a bottom wall, a horizontal rib oriented horizontally in the interior space of the side sill, and a vertical rib oriented vertically in the interior space of the side sill; and
the interior space of the side sill is partitioned into a first cavity adjacent to the inboard-side wall and a second cavity adjacent to the outboard-side wall by the vertical rib.

5. The vehicle side sill structure according to claim 4, wherein the support pads are mounted in the second cavity.

6. The vehicle side sill structure according to claim 4, wherein each support pad of the support pads has an inboard-side surface contacting the vertical rib, a top surface contacting the horizontal rib, a bottom surface contacting the bottom wall, and an outboard-side surface spaced apart from the outboard-side wall.

7. The vehicle side sill structure according to claim 4, wherein:
each support pad of the support pads includes an upper recess provided in a top surface thereof and a lower recess provided in a bottom surface thereof;
the side sill includes an upper projection protruding from the horizontal rib toward the bottom wall and a lower projection protruding from the bottom wall toward the horizontal rib;
the upper projection is fitted into the upper recess; and
the lower projection is fitted into the lower recess.

8. The vehicle side sill structure according to claim 4, wherein:
a side mount of a battery assembly disposed below the floor is mounted on the bottom wall of the side sill through mounting hardware, and
the mounting hardware is received in the first cavity of the side sill.

9. The vehicle side sill structure according to claim 4, wherein:
the side sill further includes a brake tube holder attached to the inboard-side wall; and
the brake tube holder is configured to hold a brake tube extending along the inboard-side wall of the side sill.

10. The vehicle side sill structure according to claim 9, wherein:
the side sill further includes a stud protruding from the inboard-side wall away from the side sill; and
the brake tube holder is mounted on the stud.

11. The vehicle side sill structure according to claim 4, further comprising a side sill molding mounted on the outboard-side wall of the side sill.

12. The vehicle side sill structure according to claim 1, wherein the cooling pipe is configured to fluidly connect power electronics (PE) components of a vehicle.

13. A vehicle, comprising:
a floor;
a side sill connected to an edge of the floor;
a cooling pipe accommodated in an interior space of the side sill, the cooling pipe extending in a longitudinal direction of the side sill; and
a plurality of support pads disposed to support the cooling pipe in the longitudinal direction of the side sill.
